(19) United States
(12) Patent Application Publication
(10) Pub. No.: US 2025/0328394 A1
(43) Pub. Date: Oct. 23, 2025

(54) COMBINING AVAILABLE COMPONENTS INTO VIRTUAL CLUSTERS

(71) Applicant: International Business Machines Corporation, Armonk, NY (US)

(72) Inventors: Anand Eswaran, Bengaluru (IN); Mudit Verma, New Delhi (IN); Pankaj Thorat, Bangalore (IN); Praveen Jayachandran, Bangalore (IN); Aishwariya Chakraborty, Bankura (IN)

(21) Appl. No.: 18/638,395

(22) Filed: Apr. 17, 2024

(51) Int. Cl. G06F 9/50; G06F 9/54

(52) U.S. Cl. CPC G06F 9/5083; G06F 9/547

(57) ABSTRACT

A computer-implemented method, according to one approach, includes: maintaining an inventory of available data storage and/or data processing components in a distributed system. A data request is received, and the computer-implemented method further includes determining a combination of the available data storage and/or data processing components that is capable of satisfying the data request. The combination of available data storage and/or data processing components is synthesized into a virtual cluster, and the virtual cluster is used to satisfy the data request.

### BACKGROUND

The present invention relates to persistence-aware clusters, and more specifically, this invention relates to virtually combining different components.

As computing power continues to advance and the use of Internet of Things (IoT) devices becomes more prevalent, the amount of data produced continues to increase. For instance, the rise of smart enterprise endpoints has led to large amounts of data being generated at remote locations. Data production will only further increase with the growth of 5G networks and an increased number of connected mobile devices. This issue has also become more prevalent as the complexity of machine learning models increases. Increasingly complex machine learning models translate to more intense workloads and increased strain associated with applying the models to received data. The operation of conventional implementations has thereby been negatively impacted.

While cloud computing has been implemented in conventional systems in an effort to improve the ability to process this increasing amount of data, the unprecedented scale and complexity at which data is being created has outpaced network and infrastructure capabilities. Sending all device-generated data to a centralized data center or to a cloud location has resulted in bandwidth and latency issues in conventional systems.

In an attempt to combat this reliance on a network to perform all processing at a central location, edge computing has been implemented to extend computing to the endpoints of a system. For instance, performance of applications may be moved to the edge locations where the data is generated. While this may allow for simple operations to be performed at the edge locations, more complex requests may simply be unsupported at edge locations.

### SUMMARY

A computer-implemented method (CIM), according to one approach, includes: maintaining an inventory of available data storage and/or data processing components in a distributed system. A data request is received, and the CIM further includes determining a combination of the available data storage and/or data processing components that is capable of satisfying the data request. The combination of available data storage and/or data processing components is synthesized into a virtual cluster, and the virtual cluster is used to satisfy the data request.

A computer program product (CPP), according to another approach, includes: a set of one or more computer-readable storage media. The CPP further includes program instructions that are collectively stored in the set of one or more storage media, and which are for causing a processor set to perform the foregoing CIM.

A computer system (CS), according to yet another approach, includes: a processor set, and a set of one or more computer-readable storage media. The CS also includes program instructions that are collectively stored in the set of one or more storage media, and which are for causing the processor set to perform the foregoing CIM.

Other aspects and implementations of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one approach.

FIG. 2 is a representational view of a distributed system, in accordance with one approach.

FIG. 3 is a flowchart of a method, in accordance with one approach.

FIG. 4 is a representational view of the steps for forming and using a virtual cluster are shown in accordance with an in-use example.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred approaches of systems, methods and computer program products for maintaining (e.g., monitoring) available data processing and data storage resources with different capabilities in multiple on-premise, edge, and public cloud environments. Approaches are able to evaluate these resources and combine them into unique groupings that take on combined characteristics of the individual resources. These combined data processing and data storage resources may thereby be presented as a single logical data processing cluster that is subject to requested capabilities and resource limits of consumers. Approaches herein are thereby able to offer a flexible data processing abstraction that can provide pooling of data processing capabilities and/or data storage capabilities across multi-cloud environments that are preferably in proximity to each other, e.g., as will be described in further detail below.

In one general approach, a CIM includes: maintaining an inventory of available data storage and/or data processing components in a distributed system. A data request is received, and the CIM further includes determining a combination of the available data storage and/or data processing components that is capable of satisfying the data request. The combination of available data storage and/or data processing components is synthesized into a virtual cluster, and the virtual cluster is used to satisfy the data request.

In another general approach, a CPP includes: a set of one or more computer-readable storage media. The CPP further includes program instructions that are collectively stored in the set of one or more storage media, and which are for causing a processor set to perform the foregoing CIM.

In yet another general approach, a CS includes: a processor set, and a set of one or more computer-readable storage media. The CS also includes program instructions that are collectively stored in the set of one or more storage media, and which are for causing the processor set to perform the foregoing CIM.

Various aspects of the present disclosure are described by narrative text, flowcharts, block diagrams of computer systems and/or block diagrams of the machine logic included in computer program product (CPP) approaches. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product approach (“CPP approach” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as improved virtual cluster code at block 150 for maintaining (e.g., monitoring) available data processing and data storage resources with different capabilities in multiple on-premise, edge, and public cloud environments. These resources may thereby be evaluated and combined into unique groupings that take on combined characteristics of the individual resources. These combined data processing and data storage resources may thereby be presented as a single logical data processing cluster that is used to satisfy one or more data requests, e.g., as will be described in further detail below.

In addition to block 150, computing environment 100 includes, for example, computer 101, wide area network (WAN) 102, end user device (EUD) 103, remote server 104, public cloud 105, and private cloud 106. In this approach, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and IoT sensor set 125), and network module 115. Remote server 104 includes remote database 130. Public cloud 105 includes gateway 140, cloud orchestration module 141, host physical machine set 142, virtual machine set 143, and container set 144.

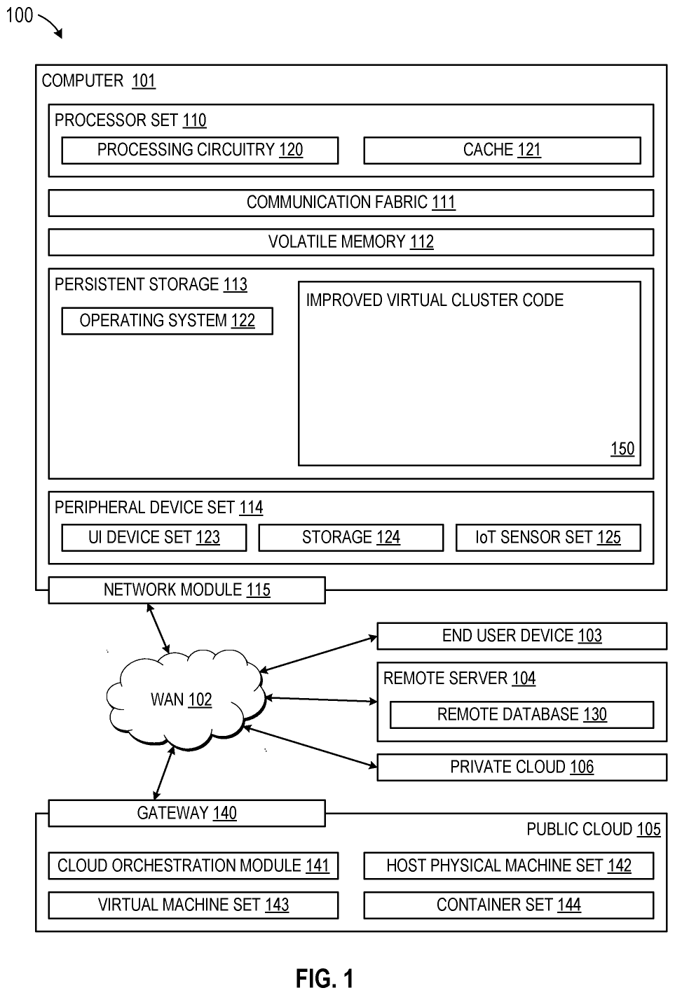

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various approaches, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some approaches, storage 124 may take the form of a quantum computing storage device for storing data in the form of qubits. In approaches where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some approaches, network control functions and network forwarding functions of network module 115 are performed on the same physical hardware device. In other approaches (for example, approaches that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some approaches, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some approaches, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other approaches a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this approach, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some approaches, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of application program interfaces (APIs). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on-demand, and virtual private networks.

In some aspects, a system according to various approaches may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various approaches.

As noted above, data production has continued to increase as computing power and the use of IoT devices advance. For instance, the rise of smart enterprise endpoints has led to large amounts of data being generated at remote locations. Data production will only further increase with the growth of 5G networks and an increased number of connected mobile devices. This issue has also become more prevalent as the complexity of machine learning models increases. Increasingly complex machine learning models translate to more intense workloads and increased strain associated with applying the models to received data. The operation of conventional implementations has thereby been negatively impacted.

While cloud computing has been implemented in conventional systems in an effort to improve the ability to process this increasing amount of data, the unprecedented scale and complexity at which data is being created has outpaced network and infrastructure capabilities. Sending all device-generated data to a centralized data center or to a cloud location has resulted in bandwidth and latency issues in conventional systems.

In an attempt to combat this reliance on a network to perform all processing at a central location, edge computing has been implemented to extend computing to the endpoints of a system. For instance, performance of applications may be moved to the edge locations where the data is generated. While this may allow for simple operations to be performed at the edge locations, more complex requests may simply be unsupported at edge locations. Conventional products have thereby been forced to continue directing a majority of I/O traffic to a centralized location, remaining dependent on network performance and subjecting the central components to high strain. Additionally, cloud-native microservices are scoped to cluster boundaries. As a result, managing workloads across multiple clusters involves remodeling applications as well as factoring in out-of-band orchestration capabilities in order to support multi-cloud capabilities. These conventional products thereby often experience inadequate performance.

In sharp contrast to the aforementioned conventional shortcomings, approaches herein achieve an improved process of selectively combining available resources on the fly, creating tailored data processing and/or storage environments. Depending on the approach, data processing and/or storage components from multiple public and/or private cloud implementations may be used to form the tailored environments. Accordingly, data persistence standards, cloud capability standards (e.g., TPUs, SR-IOV, Intel Enclaves, etc.), network performance, data collocation, etc., may be taken into consideration while determining a configuration that forms a virtualized cluster capable of satisfying a data request. The virtualized cluster may thereby expose standardized cluster APIs (e.g., Kubernetes™) and standardized object store abstractions at multiple levels (e.g., S3 API, Parquet tabular API, etc.). One implication of these abstractions is that multi-cloud native applications will think they are running on a single cluster that has sufficient processing and/or storage capabilities. Multi-cloud applications may thereby continue to be built using understood design principles, such as microservices design model, horizontal elasticity, etc., in combination with the approaches described herein, e.g., as would be appreciated by one skilled in the art after reading the present description.

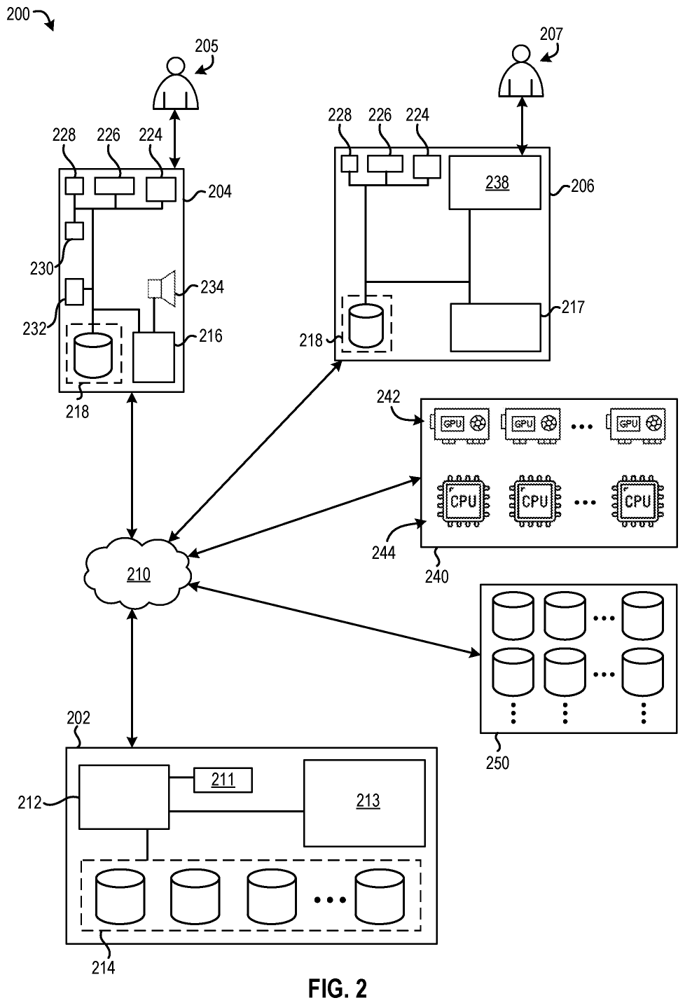

Looking now to FIG. 2, a distributed system 200 having a distributed architecture is illustrated in accordance with one approach. As an option, the present system 200 may be implemented in conjunction with features from any other approach listed herein, such as those described with reference to the other FIGS., such as FIG. 1. However, such system 200 and others presented herein may be used in various applications and/or in permutations which may or may not be specifically described in the illustrative approaches or implementations listed herein. Further, the system 200 presented herein may be used in any desired environment. Thus FIG. 2 (and the other FIGS.) may be deemed to include any possible permutation.

As shown, the distributed system 200 includes a central server 202 that is connected over network 210 to a number of remote locations having data storage and/or data processing components that are able to satisfy a data requests, therein. Specifically, central server 202 is connected to a user device 204, an edge node 206, a processing module 240, and storage module 250. The user device 204 is further accessible to the user 205, while the edge node 206 is assessable to developer 207. The user device 204 and/or the edge node 206 may thereby be considered “client devices,” each of which are connected to the central server 202.

As noted above, the central server 202, user device 204, edge node 206, processing module 240, and storage module 250 are each connected to a network 210, and may thereby be positioned in different geographical locations. The network 210 may be of any type, e.g., depending on the desired approach. For instance, in some approaches the network 210 is a WAN, e.g., such as the Internet. However, an illustrative list of other network types which network 210 may implement includes, but is not limited to, a LAN, a PSTN, a SAN, an internal telephone network, etc. As a result, any desired information, data, commands, instructions, responses, requests, etc. may be sent between user device 204, edge node 206, central server 202, processing module 240, and/or storage module 250, regardless of the amount of separation which exists therebetween, e.g., despite being positioned at different geographical locations. According to some approaches, at least some of the locations connected to network 210 correspond to a different remote cloud server that is connected to (e.g., may be accessed by) user device 204 and/or edge node 206.

It should also be noted that two or more of the user device 204, edge node 206, central server 202, processing module 240, and storage module 250 may be connected differently depending on the approach. According to an example, which is in no way intended to limit the invention, two servers (e.g., nodes) may be located relatively close to each other and connected by a wired connection, e.g., a cable, a fiber-optic link, a wire, etc.; etc., or any other type of connection which would be apparent to one skilled in the art after reading the present description.

The terms “user” and “developer” are in no way intended to be limiting. For instance, while users and developers may be described as being individuals in various implementations herein, a user and/or a developer may be an application, an organization, a preset process, etc. in other approaches. The use of “code,” “data,” and “information” herein are in no way intended to be limiting either, and may include any desired type of details, e.g., depending on the type of operating system implemented on the user device 204, edge node 206, central server 202, processing module 240, and/or storage module 250.

With continued reference to FIG. 2, the central server 202 includes a large (e.g., robust) processor 212 coupled to a cache 211, an AI module 213, and a data storage array 214 having a relatively high storage capacity. The AI module 213 may include any desired number and/or type of AI based models, e.g., such as machine learning models, deep learning models, neural networks, etc. In preferred approaches, the AI module 213 includes models that have been trained to assist in determining a combination of data storage and/or data processing components to merge for satisfying a given data request. In some approaches, the AI module 213 may work along with processor 212 to maintain an updated inventory of data storage and data processing components that are currently available. AI module 213 and processor 212 may be configured to identify a preferred combination of data storage and/or data processing components to combine in order to satisfy one or more received data requests.

AI module 213 and processor 212 may further be configured to implement data mill abstraction in forming a virtual cluster to satisfy a data request as described in various approaches herein. Thus, at a high-level, given an intent object outlining one or more combined clusters of specific types, a set of data storage and/or data processing components may be combined and used to meet the data processing objectives and constraints. Approaches herein form a virtual data processing cluster (also referred to herein as a “data mill”) using components borrowed from multiple different locations. The data mill may include pooled processing capabilities that have been exposed by a Kubernetes™ style cluster API. The data mill may also include storage capacity that has been exposed by standardized cloud storage APIs e.g., Parquet data set APIs.

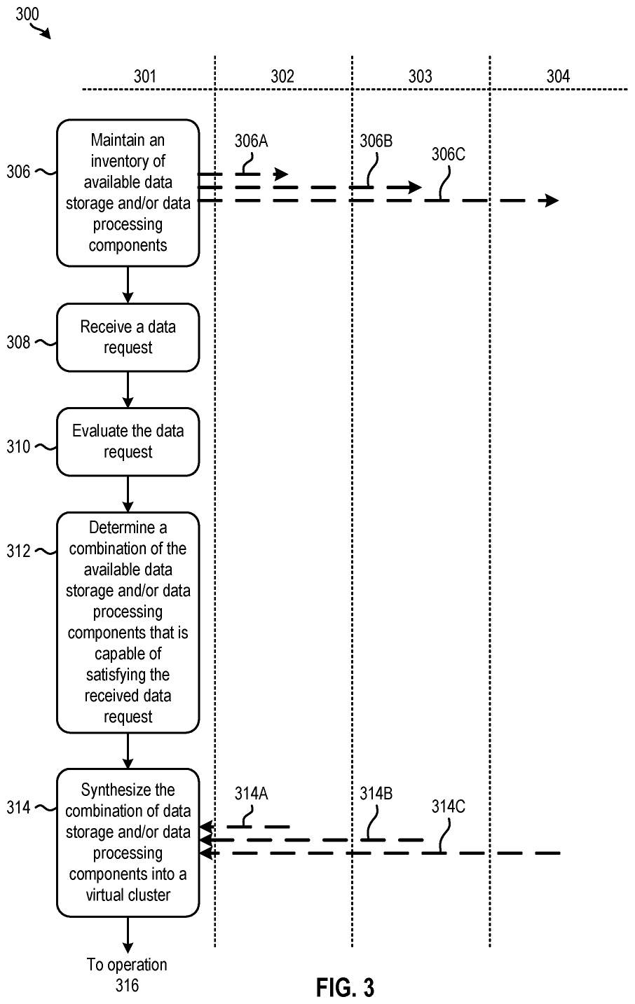

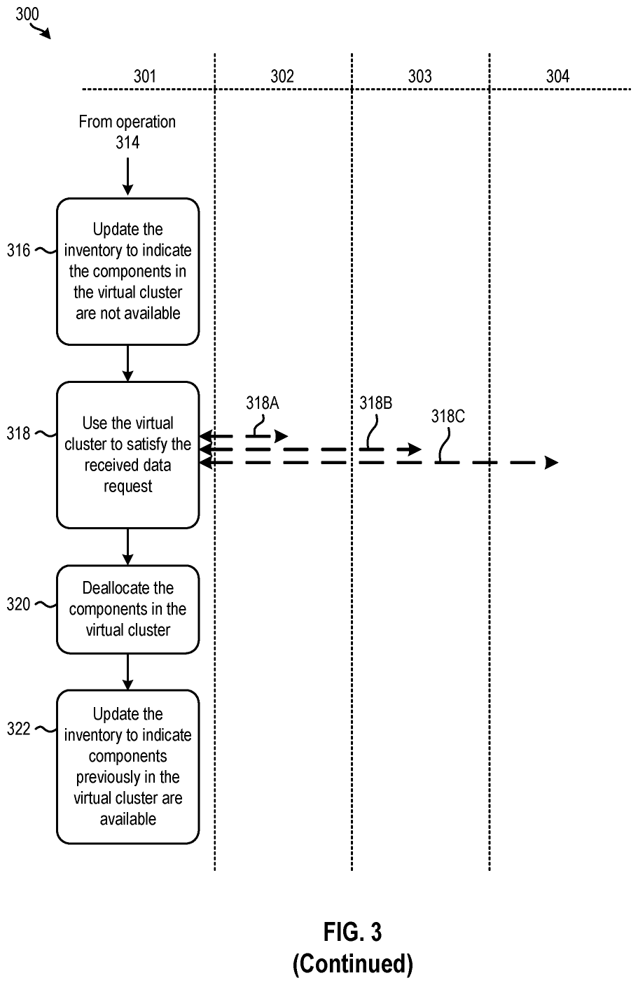

The AI based models may be configured to weigh (e.g., consider) certain details about the data storage and/or data processing components while determining a combination to synthesize into a virtual cluster. For example, the models may be configured to weigh data storage and/or data processing components based on how close they are physically located to each of the other components. Selecting a combination of data storage and/or data processing components that is able to satisfy a data request, and which also has a lowest total distance between the components, desirably reduces latency associated with actually performing (e.g., satisfying) the data request. In other words, by selecting data storage and/or data processing components that are located near each other, network delay is minimized. AI module 213 and/or processor 212 may also be configured to perform one or more of the operations in method 300 of FIG. 3, e.g., as will be described in further detail below.

With continued reference to FIG. 2, user device 204 includes a processor 216 which is coupled to memory 218. The processor 216 receives inputs from and interfaces with user 205. For instance, the user 205 may input information using one or more of: a display screen 224, keys of a computer keyboard 226, a computer mouse 228, a microphone 230, and a camera 232. The processor 216 may thereby be configured to receive inputs (e.g., text, sounds, images, motion data, etc.) from any of these components as entered by the user 205. These inputs typically correspond to information presented on the display screen 224 while the entries were received. Moreover, the inputs received from the keyboard 226 and computer mouse 228 may impact the information shown on display screen 224, data stored in memory 218, information collected from the microphone 230 and/or camera 232, status of an operating system being implemented by processor 216, etc. The user device 204 also includes a speaker 234 which may be used to play (e.g., project) audio signals for the user 205 to hear.

In some approaches, data, requests, commands, etc., may be submitted by user 205 via user device 204 and central server 202. For instance, data requests may be received from user 205 through user device 204 for implementation at central server 202. The data requests may be received as a result of the user 205 using one or more applications, software programs, temporary communication connections, etc., that may be running on the user device 204. For example, the user 205 may access user device 204 to enter (e.g., type) data request instructions into a command prompt and upload the instructions for evaluation at central server 202 and performance across the distributed system 200.

Looking now to the edge node 206, some of the components included therein may be the same or similar to those included in user device 204, some of which have been given corresponding numbering. For instance, controller 217 is coupled to memory 218, a display screen 224, keys of a computer keyboard 226, and a computer mouse 228. Additionally, the controller 217 is coupled to an AI module 238. As described above with respect to AI module 213, the AI module 238 may include any desired number and/or type of AI based models, e.g., such as machine learning models, deep learning models, neural networks, etc. However, in preferred approaches the AI module 238 includes models that have been trained to assist in determining a combination of data storage and/or data processing components to merge for satisfying one or more given data requests as described herein. For instance, the AI module 238 may work along with controller 217 to maintain an updated inventory of data storage and data processing components that are currently available. AI module 238 and controller 217 may further be configured to identify a preferred combination of data storage and/or data processing components to combine in order to satisfy one or more received data requests. AI module 238 and/or controller 217 may also be configured to perform one or more of the operations in method 300 of FIG. 3 below.

Referring still to FIG. 2, the distributed system 200 further includes a processing module 240 and a storage module 250. As their names suggest, the processing module 240 may be used to perform one or more data processing operations, while the data storage module 250 may be used to perform one or more data storage operations. The processing module 240 is thereby shown as including a number of data processing components that may be used to perform the data processing operations, e.g., depending on the types of data processing operations that are supported by the components in the processing module 240. For instance, the processing module 240 includes an array of graphics processing units (GPUs) 242 that may be used to perform various data processing related operations. In some approaches, one or more of the GPUs in the array 242 may be used to perform one or more computations corresponding to received requests. The processing module 240 also includes an array of central processing units (CPUs) 244 that may be used to perform data processing related operations. In some approaches, one or more of the CPUs in the array 244 may be used to execute one or more instructions received from hardware and/or software programs running on a corresponding device.

Looking to data storage module 250, a number of data storage components configured to store and access data are included therein. In some approaches the data storage module 250 serves as a data lake and/or a data lakehouse, providing a centralized repository for managing large data volumes. The data storage module 250 and data storage components therein may serve as a foundation for collecting and analyzing structured, semi-structured and unstructured data in its native format for long-term storage. Data storage module 250 is also able to use the various data stored therein to drive insights and predictions. For example, the data storage module 250 may store training datasets that may be used to train AI based models as described herein.

The connection that central server 202 has over network 210 to the various other data storage and/or data processing components allows for them to be logically combined in different configurations. In other words, the data storage and/or data processing components spread across system 200 may be merged such that the capabilities of each component in a combined set of compliments merge to achieve a desired outcome. For instance, processor 212 and/or AI module 213 may be configured to perform one or more of the operations in method 300 below to determine specific combinations of available data storage and/or data processing components that are configured to efficiently satisfy received data requests, e.g., as will be described in further detail below. However, it should be noted that one or more of the operations in method 300 may be performed by any capable components in FIG. 2, e.g., such as controller 217 and/or AI module 238 of edge node 206. Further still, it should be noted that the specific types of data storage and/or data processing components shown in FIG. 2 are in no way intended to be limiting. For example, while processing module 240 is depicted as including an array of GPUs 242 and an array of CPUs 244, this is in no way intended to be limiting and any desired type(s) of data processing components may be implemented in any desired configuration.

Looking now to FIG. 3, a flowchart of a computer-implemented method 300 for maintaining (e.g., monitoring) available data processing and data storage resources with different capabilities in multiple on-premise, edge, and public cloud environments. The operations in method 300 are able to evaluate these resources and combine them into unique groupings that take on combined characteristics of the individual resources. These combined data processing and data storage resources may thereby be presented as a single logical data processing cluster that is subject to requested capabilities and resource limits of consumers. Method 300 is able to offer a flexible data processing abstraction that can provide pooling of data processing capabilities and/or data storage capabilities across multi-cloud environments that are preferably in proximity to each other, e.g., as will be described in further detail below.

The method 300 may be performed in accordance with the present invention in any of the environments depicted in FIGS. 1-2, among others, in various approaches. Of course, more or fewer operations than those specifically described in FIG. 3 may be included in method 300, as would be understood by one of skill in the art upon reading the present descriptions. Each of the steps of the method 300 may further be performed by any suitable component of the operating environment. For example, the nodes 301, 302 shown in the flowchart of method 300 may correspond to one or more processors positioned at a different location in a distributed system. Moreover, each of the one or more processors are preferably configured to communicate with each other.

In various approaches, the method 300 may be partially or entirely performed by a controller, a processor, etc., or some other device having one or more processors therein. The processor, e.g., processing circuit(s), chip(s), and/or module(s) implemented in hardware and/or software, and preferably having at least one hardware component may be utilized in any device to perform one or more steps of the method 300. Illustrative processors include, but are not limited to, a central processing unit (CPU), an application specific integrated circuit (ASIC), a field programmable gate array (FPGA), etc., combinations thereof, or any other suitable computing device known in the art.

As mentioned above, FIG. 3 includes different nodes 301, 302, 303, 304, each of which represent one or more processors, controllers, computer, etc., at a different location in a distributed system. For instance, node 301 may include one or more processors which are located at a central server configured to suggest, construct, and manage a virtual cluster (e.g., see processor 212 at central data storage location 202 of FIG. 2 above). Node 302 may include one or more processors which are included at a first edge node of a distributed system (e.g., see controller 217 at edge node 206 of FIG. 2 above). Similarly, nodes 303 and 304 may each include one or more processors at respective modules having data storage and/or data processing components therein (e.g., processors included in processing module 240 and storage module 250 of FIG. 2 above). It follows that commands, data, requests, etc. may be sent between each of the nodes 301, 302, 303, 304 depending on the approach. Moreover, it should be noted that the various processes included in method 300 are in no way intended to be limiting, e.g., as would be appreciated by one skilled in the art after reading the present description. For instance, data sent from node 302 to node 303 may be prefaced by a request sent from node 303 to node 302 in some approaches.

Looking to FIG. 3, operation 306 is performed at node 301. There, operation 306 includes maintaining an inventory of available data storage and/or data processing components in a distributed system. In other words, operation 306 includes monitoring performance of various data storage and/or data processing components that are spread across environments accessible to (e.g., connected to a same network as) a central server. Accordingly, dashed lines 306A, 306B, 306C are shown extending between node 301 and nodes 302, 303, 304. In some approaches, performance of the various components is tracked at the respective nodes 302, 303, 304 and transmitted back to node 301 in real-time. Moreover, the performance may be recorded in a lookup table. Data storage and/or data processing components that are currently being used to satisfy data requests, other commands, etc. may be labeled as not available in the lookup table being managed, while data storage and/or data processing components that are not currently being used may be labeled as available in the lookup table. Maintaining an inventory thereby desirably provides an accurate overview of the various data storage and/or data processing components that are available to satisfy incoming requests.

While operation 306 is shown as a single operation in FIG. 3, the data processing and/or data storage components in a distributed system may continue to be monitored. For instance, operation 306 may be repeated any desired number of times in an iterative fashion until a data request is received, whereby additional operations in method 300 may be performed in order to satisfy the received request. However, operation 306 may continue to be performed in the background while the additional operations in method 300 are performed (e.g., in parallel).

As shown, method 300 advances from operation 306 to operation 308, where a data request is received. Moreover, operation 310 includes evaluating the received data request. Depending on the approach, the data request may involve one or more data processing and/or data storage related operations. In some approaches, the data request received may actually be a data mill intent object that involves a data storage and/or data processing workload. The data request may thereby outline the type and/or number of operations that are projected to be performed as a result of fully satisfying the data request in some approaches.

The data request may also be received from a number of different sources depending on the approach. In some approaches, the data request is received at a central server from a user with access to the central server through a user device, edge server, etc. In other approaches, the data request may be received from a running application, as a result of one or more AI based models generating an output, automatically in response to a predetermined condition being met, etc.

From operation 310, method 300 advances to operation 312. There, operation 312 includes determining a combination of the available data storage and/or data processing components that is capable of satisfying the received data request. The performance capabilities of each available data storage and/or data processing component (also referred to herein as “resource” or “resources”) is considered while determining the combination ultimately used to field the received data request. For example, current storage capacity, write latency, storage type, etc., of available data storage components may be considered while evaluating a received data storage request. Similarly, achievable throughput, processing limitations, supported programming languages, etc., of available data programming components may be considered while evaluating a received data processing request. According to a non-limiting example, the resources evaluated and considered during operation 312 includes hardware accelerators (e.g., such as GPUs) which are computer hardware that have been designed to perform specific functions more efficiently when compared to software running on a general-purpose central processing unit (CPU). It follows that by evaluating various resources, e.g., such as hardware accelerators, while determining a combination of devices to use ensures that the request is satisfied in an efficient manner.

In addition to performance capabilities, additional characteristics of each available component may also be taken into consideration while selecting a combination that is used to satisfy a received data request. For instance, data storage and/or data processing components separated by greater physical distances experience higher latency than components that are located physically closer to each other. Thus, combinations of data storage and/or data processing components that are positioned more closely to each other may be given priority (e.g., favorably weighted) for implementation over combinations of components that are more spread apart.

The process of determining a combination of available data storage and/or data processing components that is capable of satisfying the data request may thereby consider the physical distance between the components. Comparing the distance between the available data storage and/or data processing components allows for approaches herein to select an arrangement of the available data storage and/or data processing components that are (i) capable of satisfying the data request, and (ii) have a lowest combined physical (e.g., geographical) distance therebetween. In other approaches, a combination of components that has a lowest average distance between the components, a lowest maximum distance between the components, a lowest change (e.g., delta) among the distances between the components, etc.

Other factors may also contribute to latency experienced by a collection of components being used to perform a data request. For example, certain components may be logically configured differently (e.g., implement software written in different programming languages), leading to a more complicated exchange of information between the components. This logical conflict between the components may thereby introduce latency that impacts performance of the data request. Some approaches may further refer to processing site selector rules, data site selector rules, or any other guidelines outlining how the data storage and/or data processing components should be combined. For example, some guidelines may provide an overview of components that cannot be combined with each other.

According to some approaches, a combination of data processing and/or data storage components may be selected to satisfy a data request using data mill synthesis. A data mill synthesizer may be used to select the individual clusters and workers at those clusters that will embody the data mill abstraction. One illustrative example, which is in no way intended to be limiting, involves using a Kubernetes™-style “prune-and-score” progression. A first phase of the progression includes eliminating (e.g., pruning) sites that do not provide at least one capability (e.g., characteristic) associated with the data request being satisfied. In a second phase, each remaining site is assigned a score (e.g., weight) based on various factors, e.g., such as residual load, scarcity of capability at hand, etc. The data mill synthesizer may further rank potential sites based on capabilities, and incrementally add select sites to a combination (e.g., collection) until a desired set of capabilities are supported. Corresponding to these decisions, worker nodes at each site may be assembled into site-local clusters. A minimal API server may also be instantiated (e.g., realized using Kubernetes™ control plane (KCP) or similar mechanism) that acts as the data mill endpoint and is responsible for interfacing with the site-local clusters, e.g., as will be described in further detail below.

Referring still to FIG. 3, method 300 advances from operation 312 to operation 314 in response to determining the combination of available data storage and/or data processing components (e.g., resources) to use in order to satisfy the received data request. There, operation 314 includes synthesizing the combination of available data storage and/or data processing components into a virtual cluster. In other words, operation 314 includes combining the various data storage and/or data processing components regardless of their respective physical locations, configurations, etc., and providing a single virtual cluster interface. Accordingly, sub-operations 314A, 314B, 314C synthesize a combined exchange between the data storage and/or data processing components selected in operation 312 from nodes 302, 303, 304. Although the present approach shows components being incorporated from each location (node), this is in no way intended to be limiting. As noted above, the data request received impacts the combination of components that are ultimately combined and synthesized into a virtual cluster, e.g., as would be appreciated by one skilled in the art after reading the present description.

As noted above, a minimal API server may be instantiated and act as the data mill endpoint that is responsible for interfacing with the site-local clusters. In some approaches, synthesizing of the combination of components determined in operation 312 into a virtual cluster includes using geo-distributed control plane constructs (e.g. KCP) and a virtual data lake synthesizer to synthesize the combination of components. In some approaches, synthesizing at least a portion of the combination determined in operation 312 into a virtual cluster includes mapping a virtual cluster API to a first controller configured to assign workloads to the data processing components in the virtual cluster, e.g., as outlined in a workload placement policy. In some approaches, synthesizing at least another portion of the combination determined in operation 312 into a virtual cluster includes mapping a virtual data lake API to a second controller configured to assign workloads to the data storage components in the virtual cluster, e.g., as outlined in the same or a different workload placement policy.

Method 300 advances from operation 314 to operation 316 in response to synthesizing the virtual cluster. There, operation 316 includes updating the inventory to indicate the combination of data storage and/or data processing components in the virtual cluster are not available. In some approaches, a lookup table is updated to indicate the specific data storage and/or data processing components that have been incorporated in the virtual cluster and are therefore no longer available. It follows that each data request is satisfied with an ideal combination of data processing and/or storage resources that are available around the time when the data request is received. An AI model trained to generate a combination of available data storage and/or data processing components that are: (i) capable of satisfying a data request, and (ii) which have a lowest total physical distance between the components, may thereby produce a different outcome as components are added to the system, are removed from the system, are placed in use, become available, etc. over time. In some approaches, one or more AI models may be trained to implement a different tolerance in terms of the distance separating the components included in a combination. For example, the amount of available data processing and/or data storage components may impact a maximum acceptable distance between components used in combination to satisfy a data request.

Proceeding from operation 316 to operation 318, there the virtual cluster is used to seamlessly satisfy the received data request. In other words, operation 318 includes performing a series of steps 318A, 318B, 318C to use the various selected data processing and/or data storage components from the different (e.g., preferably proximal) nodes 302, 303, 304 to satisfy the data request received at node 301. This is preferably done in such a way that a user that may have submitted the request is unaware the corresponding physical components used to satisfy the submitted request are distributed across different physical locations.

According to some approaches, steps 318A, 318B, 318C may include deploying a target workload using a resource consumption API. For example, a Kubernetes™ API corresponding to the virtual cluster exposed via a KCP end-point may be used to deploy a target workload across the selected combination of data processing and/or data storage components. Include sending one or more instructions to cloud environments associated with the data storage and/or data processing components in the virtual cluster. Accordingly, the one or more instructions may cause the cloud environments to use the data storage and/or data processing components to satisfy a respective portion(s) of the data request.

With continued reference to FIG. 3, method 300 advances from operation 318 to operation 320 in response to the data request being satisfied. There, operation 320 includes deallocating the combination of data storage and/or data processing components in the virtual cluster. In other words, the data storage and/or data processing components used to satisfy the data request are preferably released after the data request has been completed. This allows the components to be available for use in satisfying subsequent data requests. While it may be preferred in some approaches that data storage and/or data processing components are deallocated as soon as the data request is satisfied, other approaches may maintain the combination of components. For example, a stream of similar data requests, predetermined request submission timetables, user requests, etc., may be used as support for maintaining a particular configuration of data processing and/or data storage components in-use for any extended amount of time.

Furthermore, operation 322 includes updating the inventory to indicate the combination of data storage and/or data processing components previously in the virtual cluster are now available. As noted above, a lookup table is updated in some approaches to indicate the specific data storage and/or data processing components that have been released from the virtual cluster and are therefore available.

It follows that method 300 is desirably able to create a virtual cluster that is used to seamlessly satisfy received data requests. This is preferably done in such a way that a user that may have submitted the request is unaware the corresponding physical components used to satisfy the submitted request are distributed across different physical locations. This allows for capabilities to be combined, such that a number of individual sites are used to form a same virtual cluster. Moreover, applications are exposed to an aggregate capacity of the virtual cluster without being constrained by physical capacity of clusters.

These improvements are further achieved without making applications aware that they are running on virtual clusters as compared to regular physical clusters, e.g., as would be appreciated by one skilled in the art after reading the present description. For instance, a cluster API may be mapped to different physical data processing and/or data storage components, that together make up the data processing virtual cluster. In some approaches, the cluster API may be mapped to the components in a policy-driven manner. According to a non-limiting example, a clustering policy may outline it is preferred that cloud sites are used to satisfy scheduling workloads after exhausting on-premise capacity.

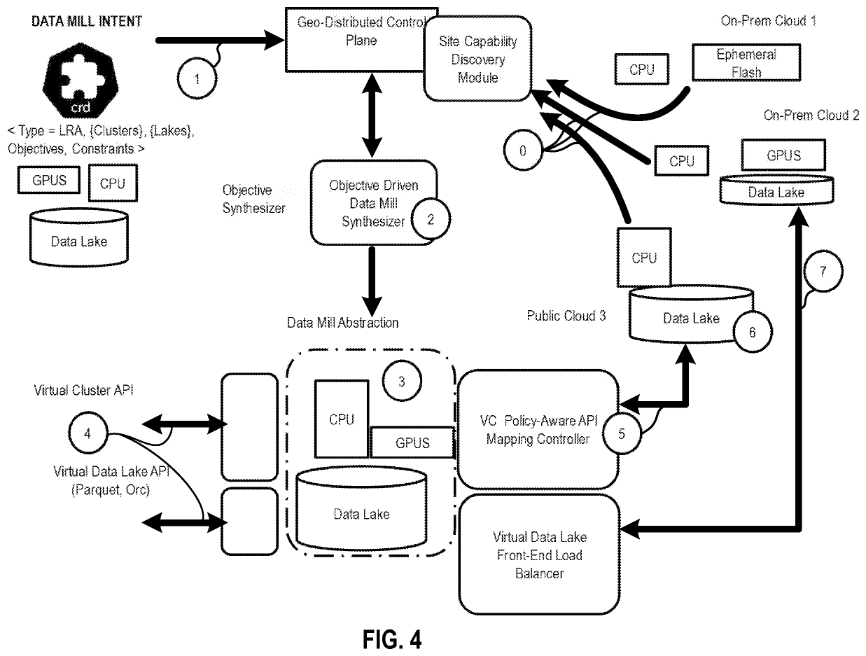

Referring now to FIG. 4, a representational view of the steps for forming and using a virtual cluster are shown in accordance with an in-use example which is in no way intended to be limiting. It follows that any one or more of the steps in FIG. 4 described below may be implemented with any of the other approaches described herein.

Step 0 “0” includes discovering and monitoring an inventory (e.g., repository) of available data processing and/or data storage components. These components are spread across On-Prem Cloud Environment 1, On-Prem Cloud Environment 2, and Public Cloud Environment 3. Moreover, the detailed organization of the available components may incorporate the schema outlined in a received data mill intent specification, e.g., as would be appreciated by one skilled in the art after reading the present description.

Proceeding to Step 1 “1”, a data mill intent object is received at a multi-cloud computer (e.g., controller). This may be specified as per the schema outlined in the data mill intent specification. Moreover, Step 2 “2” includes selecting a set of components at different ones of the On-Prem Cloud Environment 1, On-Prem Cloud Environment 2, and Public Cloud Environment 3, which together can satisfy one or more data requests. Moreover, the components in the data mill may be selected using Processing Site Selector rules, Data Site Selector rules, etc., that may be specified in the received intent object. Proceeding to Step 3 “3”, virtual clusters may thereby be synthesized using the geo-distributed control plane constructs (e.g. KCP) and using the virtual data lake synthesizer as shown.

Step 4 “4” further includes making the data mill available for use, e.g., such that it can be consumed by deploying target workload using resource consumption API. For example, a Kubernetes™ based API corresponding to the virtual cluster may be exposed via a KCP end-point. The flowchart advances to Step 5 “5” in response to the workload being submitted. There, Step 5 includes mapping the API to the virtual cluster “VC” policy-aware controller that is responsible for mapping workloads to appropriate clusters that form the data mill as per the workload placement policy. Accordingly, at Step 6 “6”, the target cluster receiving the cluster API is unaware that it is actually part of a virtual cluster.

In some approaches, a virtual cluster mapper is used to perform the mapping in Steps 4 and/or 5. Thus, in situations where an API request arrives at the data mill endpoint, this is intercepted, translated, and mapped to the appropriate back-end endpoint by the virtual cluster mapper. This is typically done in a policy-driven manner and on a per cluster-API basis. The process may be transparently intercepted and translated to a call to deploy a workload may pick any eligible back-end cluster (where eligibility is defined by cluster nodes having capabilities and/or labels matching the workload) with minimum load. For example, the policy configured in the virtual cluster may be LEAST_LOADED_CLUSTER. It should also be noted that the data mill API server has controllers for important resource types and is able to intelligently map and split commands across multiple back-end clusters intelligently.

Furthermore, at Step 7 “7” the data lake API end-point is hosted by the virtual data lake front-end load balancer. Applications connect to the virtual data lake connector. This allows for implementing data lake pooling by remapping the cloud object get/put API in a policy-compliant manner, e.g., as specified in load-balancing policy derived from the data placement policy to the target object store. Given that data APIs in data mills are realized via an object store abstraction rather than via a persistent-volume abstraction (this is intentional to achieve a higher abstraction for data-processing), all reads/writes may be assumed to be S3-style APIs (involving get( )/put( ) of objects identified by keys). In such approaches, because all data operations are via S3-style read/write APIs, incoming S3 APIs arrive at a virtual data-mill end-point, and this is in turn intercepted and mapped transparently by the data-mill controller to one of the back-end data lake stores in a policy-aware manner. Moreover, this is done without violating any data policy constraints. In a preferred version, S3 path-names can be routed using L7 load-balancing directly to a back-end store without app-layer termination (interception), thereby resulting in a more efficient implementation, e.g., as would be appreciated by one skilled in the art after reading the present description.

As described herein, “data mills” may serve as a fundamental primitive in multi-cloud computer implementations focused on data processing capabilities, e.g., particularly modern workloads like foundation models, deep AI, etc. Data mills can also form a middleware layer on top of applications and can potentially be wrapped with other ecosystems. Data mills can be used in foundation model stacks for realizing data intensive pipelines such as foundation model preprocessing for multi-cloud and geo-distributed settings.

As noted above, approaches herein are able to expose capabilities of multiple clusters transparently to applications which think they are running on a single cluster. This is particularly desirable in edge use cases which are often resource constrained and/or configured with different capabilities. Approaches herein integrate the pooling (e.g., accumulation in queues) data processing components (e.g., compute accelerators, memory accelerators, domain accelerators, etc.) and/or data storage components (e.g., data lakes, data caches, etc.) across multiple physical and/or logical locations into a unified “data mill” abstraction which can be used across a large set of data intensive processing tasks. Moreover, the abstraction of data mills in approaches herein supports the notion of short-lived data mills in addition to long-running data mills, e.g., depending on the approach.

Given that reserving processing and/or data capacity for a data mills (which is a spatial pool of resources aggregated from multiple clouds) is complimented in approaches herein with a run-time component that is able to intercept and map cluster and/or data APIs exposed by the mill to the appropriate target physical cluster in a policy-compliant way. This allows run-time placement decisions that are policy-compliant. Finally given that approaches are faced with ephemeral storage and/or cache pooling (that is used by intermediate data) as well as cloud object storage pooling (used by persistent data) in a unified, advantages are achieved including transparent leverage of the caching tier for caching persistent data. Approaches herein are also able to gain an accurate understanding of how decisions should be made, e.g., using AI based techniques. Some approaches can scale data mill capacity while also performing workload scheduling and placement decisions.

Some approaches are able to expose the virtual cluster abstraction of data mills towards enterprise data processing applications. This desirably allows data processing enterprise applications to include microservices that each may be distributed across different components, thereby leveraging capabilities across multiple locations. The data mill abstraction dynamically creates a virtual cluster with union capabilities and exposes the illusion to the enterprise applications that they are running on a cluster that supports union capabilities across all clouds. Approaches can transparently pool the capacity of multiple clusters (compute and storage) across multiple cloud providers that are in the same location (e.g., geographic region) and offer these transparent pools for consumption by enterprise applications. This allows enterprise applications to transparently consume disaggregated persistent and ephemeral storage (caching) that transcend the resource limits of any one cluster. This also allows enterprise applications to provide transparent failure-tolerance and reliability that transcends the fault boundary of any one site.

In one approach implementing “on-demand public-cloud” settings, the capabilities specified in the declarative intent of the data mill specification are evaluated, and the inventory of worker nodes with their supported capabilities are relayed back to the discovery module. Because the cluster is instantiated by the data-mill synthesizer, APIs can be used to copy the inventory of worker node types, capabilities of virtual machines, worker nodes, resources, etc., to the site discovery module. In another approach implementing “on-prem” settings, worker nodes are not virtual machines, but rather they are bare-metal nodes that already preexist in an on-prem datacenter. In this approach, clusters are not created on-demand. Rather, agents are installed to transfer topology information, capabilities, tags/labels, etc., of the cluster workers and/or resources to the site discovery module.

As stated above, approaches herein are desirably able to expose capabilities of multiple clusters transparently to applications which think they are running on a single cluster. This is particularly important in edge use cases which may be resource constrained and/or have different capabilities. Another desirable ability of approaches herein is to integrate both processing pooling (e.g., compute, memory, domain-accelerators, etc.) and data storage pooling (e.g., data lakes, caches, etc.) across multiple clouds into a unified “data mill” abstraction which can be used across a large set of data intensive processing tasks. Approaches are also able to account for scenarios such as data processing in foundation model preprocessing context in a multi-cloud setting, the data processing activity may be a job with a finite objective and therefore short-lived in nature. Thus, abstraction of data mills in approaches herein this notion of short-lived data mills in addition to long-running data mills. Finally given that approaches herein involve ephemeral storage and/or cache pooling (e.g., used by intermediate data) as well as cloud object storage pooling (e.g., used by persistent data) in a unified manner, advantages are achieved such as transparent leverage of the caching tier for caching persistent data.

It will be clear that the various features of the foregoing systems and/or methodologies may be combined in any way, creating a plurality of combinations from the descriptions presented above.

It will be further appreciated that implementations of the present invention may be provided in the form of a service deployed on behalf of a customer to offer service on demand.

The descriptions of the various implementations of the present invention have been presented for purposes of illustration, but are not intended to be exhaustive or limited to the implementations disclosed. Many modifications and variations will be apparent to those of ordinary skill in the art without departing from the scope and spirit of the described implementations. The terminology used herein was chosen to best explain the principles of the implementations, the practical application or technical improvement over technologies found in the marketplace, or to enable others of ordinary skill in the art to understand the implementations disclosed herein.

What is claimed is:

1. A computer-implemented method (CIM), comprising:
maintaining an inventory of available data storage and/or data processing components in a distributed system;
receiving a data request;
determining a combination of the available data storage and/or data processing components that is capable of satisfying the data request;
synthesizing the combination of available data storage and/or data processing components into a virtual cluster; and
using the virtual cluster to satisfy the data request.

2. The CIM of claim 1, wherein the determining of the combination of available data storage and/or data processing components that is capable of satisfying the data request includes:
comparing distances between each of the available data storage and/or data processing components; and
selecting an arrangement of the available data storage and/or data processing components that: are capable of satisfying the data request, and have a lowest combined distance between the selected components.

3. The CIM of claim 1, wherein the synthesizing of the combination of available data storage and/or data processing components into a virtual cluster includes:
using geo-distributed control plane constructs and a virtual data lake synthesizer to synthesize the combination of available data storage and/or data processing components.

4. The CIM of claim 1, wherein the synthesizing of the combination of available data storage and/or data processing components into a virtual cluster includes:
mapping a virtual cluster application programming interface (API) to a first controller configured to assign workloads to the data processing components in the virtual cluster.

5. The CIM of claim 4, wherein the synthesizing of the combination of available data storage and/or data processing components into a virtual cluster includes:
mapping a virtual data lake API to a second controller configured to assign workloads to the data storage components in the virtual cluster.

6. The CIM of claim 1, wherein the using of the virtual cluster to satisfy the data request includes:
deploying a target workload using a resource consumption application programming interface (API).

7. The CIM of claim 1, wherein the using of the virtual cluster to satisfy the data request includes:
sending one or more instructions to cloud environments associated with the data storage and/or data processing components in the virtual cluster, the one or more instructions causing the cloud environments to use the data storage and/or data processing components to satisfy a respective portion of the data request.

8. The CIM of claim 1, further comprising:
in response to synthesizing the virtual cluster, updating the inventory to indicate the combination of data storage and/or data processing components in the virtual cluster are not available.

9. The CIM of claim 1, further comprising:
in response to the data request being satisfied, deallocating the combination of data storage and/or data processing components in the virtual cluster; and
updating the inventory to indicate the deallocated data storage and/or data processing components are available.

10. A computer program product (CPP), comprising:
a set of one or more computer-readable storage media; and
program instructions, collectively stored in the set of one or more storage media, for causing a processor set to perform the following computer operations:
maintain an inventory of available data storage and/or data processing components in a distributed system;
receive a data request;
determine a combination of the available data storage and/or data processing components that is capable of satisfying the data request;
synthesize the combination of available data storage and/or data processing components into a virtual cluster; and
use the virtual cluster to satisfy the data request.

11. The CPP of claim 10, wherein the determining of the combination of available data storage and/or data processing components that is capable of satisfying the data request includes:
comparing distances between each of the available data storage and/or data processing components; and
selecting an arrangement of the available data storage and/or data processing components that: are capable of satisfying the data request, and have a lowest combined distance between the selected components.

12. The CPP of claim 10, wherein the synthesizing of the combination of available data storage and/or data processing components into a virtual cluster includes:
using geo-distributed control plane constructs and a virtual data lake synthesizer to synthesize the combination of available data storage and/or data processing components.

13. The CPP of claim 10, wherein the synthesizing of the combination of available data storage and/or data processing components into a virtual cluster includes:
mapping a virtual cluster application programming interface (API) to a first controller configured to assign workloads to the data processing components in the virtual cluster.

14. The CPP of claim 13, wherein the synthesizing of the combination of available data storage and/or data processing components into a virtual cluster includes:
mapping a virtual data lake API to a second controller configured to assign workloads to the data storage components in the virtual cluster.

15. The CPP of claim 10, wherein the using of the virtual cluster to satisfy the data request includes:
deploying a target workload using a resource consumption application programming interface (API).

16. The CPP of claim 10, wherein the using of the virtual cluster to satisfy the data request includes:
sending one or more instructions to cloud environments associated with the data storage and/or data processing components in the virtual cluster, the one or more instructions causing the cloud environments to use the data storage and/or data processing components to satisfy a respective portion of the data request.

17. The CPP of claim 10, wherein the program instructions are for causing the processor set to further perform the following computer operations:
in response to synthesizing the virtual cluster, update the inventory to indicate the combination of data storage and/or data processing components in the virtual cluster are not available.

18. The CPP of claim 10, wherein the program instructions are for causing the processor set to further perform the following computer operations:
in response to the data request being satisfied, deallocate the combination of data storage and/or data processing components in the virtual cluster; and
update the inventory to indicate the deallocated data storage and/or data processing components are available.

19. A computer system (CS), comprising:
a processor set;
a set of one or more computer-readable storage media;
program instructions, collectively stored in the set of one or more storage media, for causing the processor set to perform the following computer operations:
maintain an inventory of available data storage and/or data processing components in a distributed system;
receive a data request;
determine a combination of the available data storage and/or data processing components that is capable of satisfying the data request;
synthesize the combination of available data storage and/or data processing components into a virtual cluster; and
use the virtual cluster to satisfy the data request.

20. The CS of claim 19, wherein the synthesizing of the combination of available data storage and/or data processing components into a virtual cluster includes:
mapping a virtual cluster application programming interface (API) to a first controller configured to assign workloads to the data processing components in the virtual cluster; and
mapping a virtual data lake API to a second controller configured to assign workloads to the data storage components in the virtual cluster.
